(19) United States
(12) Patent Application Publication
(10) Pub. No.: US 2026/0325942 A1
(43) Pub. Date: Oct. 22, 2026

(54) REAL-TIME EQUALIZATION OF AUDIO STREAMS WITHIN A CONNECTED FITNESS PLATFORM

(71) Applicant: Peloton Interactive, Inc., New York, NY (US)

(72) Inventors: Seungyoon LEE, Evanston, IL (US); Pepin Torres, Waltham, MA (US)

(21) Appl. No.: 19/183,426

(22) Filed: Apr. 18, 2025

(51) Int. Cl. A63B 71/06; A63B 24/00; G06F 3/16; G10H 1/00; G10L 21/034; G10L 21/0364

(52) U.S. Cl. CPC A63B 71/0619; A63B 24/0062; G06F 3/165; G10L 21/034; G10L 21/0364; G10H 1/0008; G10H 2240/081

(57) ABSTRACT

The systems and methods described herein enable the equalization, adjustment, and/or modification of audio streams during exercise classes by separately equalizing different audio components of the audio streams of the exercise classes. For example, an audio equalization system may extract metadata from an audio stream, and separately adjust a music stream and an instructor stream (e.g., which combine to form the audio stream) based on the metadata.

### BACKGROUND

The world of connected fitness is an ever-expanding one. This world can include a user taking part in an exercise activity or workout (e.g., running, cycling, lifting weights, rowing, and so on), as well as other users performing similar exercise activities or workouts. For some modalities, the users perform the exercise activities using a fitness machine (e.g., a treadmill, a stationary bike, a strength machine, a stationary rower, and so on). In other modalities, the users perform the exercise activities by moving through the world (e.g., by running, bicycling, rowing, and so on) and/or by exercising without a machine, such as strength training, doing yoga, stretching, hiking, climbing, and so on.

Often, a user watches or interacts with an exercise class via a display that is part of a machine, which provides or presents interactive content to the user. For example, the display can present or stream live or recorded classes (e.g., fitness or strength classes), audio instructions, video tutorials of activities, workout plans (e.g., a list of movements), leaderboards and other competitive or interactive features, progress indicators (e.g., via time, distance, and other metrics), and so on.

### BRIEF DESCRIPTION OF THE DRAWINGS

Embodiments of the present technology will be described and explained through the use of the accompanying drawings.

FIG. 1 is a block diagram illustrating a suitable network environment for users of an exercise system.

FIG. 2 is a block diagram illustrating components of an audio equalization system.

FIG. 3 is a flow diagram illustrating an example method for equalizing an audio stream during an exercise class.

FIGS. 4A-4B are diagrams illustrating an exercise class presented to a user of an exercise machine.

FIG. 5 is a flow diagram illustrating an example method for playing an audio stream to a user of an exercise machine.

FIG. 6 is a flow diagram illustrating an example method for streaming audio content to a remote exercise machine.

In the drawings, some components are not drawn to scale, and some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

### Overview

Various systems and methods that enhance an exercise activity performed by a user are described. For example, the systems and methods may enhance or optimize the audio content of an exercise class presented to the user during performance of the exercise activity, such as when the user takes part in the exercise class via an exercise machine (e.g., an exercise bike, treadmill, rower, strength machine, and so on).

Often, an exercise class is led by an instructor, who provides spoken instructions during the class. The exercise class may also have other audio content, such as music played during the exercise class, often while the instructor is speaking instructions, cues, or other content. For example, the user (and other users) may consume a real-time exercise class via a display (e.g., a tablet) that is part of their exercise machine, which receives a stream of the exercise class from a remote server provided by a connected fitness platform.

The display presents the video and audio components of the exercise class to the user via a screen and audio components (e.g., speakers). Often, the display includes an audio rendering system that compensates for the specific hardware characteristics of the display (e.g., speaker layout and capabilities, audio drivers, and so on). The audio rendering system may perform equalization (EQ) to audio played by the display, such as audio presented during an exercise class, to modify or adjust audio presented to the user based on the specific parameters/characteristics of the display (or other devices).

However, typical audio processing, which applies modifications via a single or common audio chain, may not provide sufficient EQ for exercise classes. As described herein, exercise classes often include multiple different components, such as a music component (e.g., a set of songs) and an instructor component (e.g., words spoken by an instructor with a unique voice). Thus, the application of a single EQ to the audio content of an exercise class may introduce additional problems because a modification that enhances the music stream may adversely affect the instructor stream, and vice versa.

For example, applying EQ to electronic music (e.g., to soften a high band within the music) may also affect an instruction having a relatively higher vocal register. As another example, adjusting the bass within a rap song may adversely affect the intelligibility of words spoken with a lower (or deeper) register.

The systems and methods described herein enable the EQ, adjustment, and/or modification of audio streams during exercise classes by separately equalizing the different audio components of the audio streams of the exercise classes. For example, an audio equalization system may extract metadata from an audio stream, and separately adjust a music stream and an instructor stream (e.g., which combine to form the audio stream) based on the metadata.

In doing so, the systems and methods may enhance the audio playback of an exercise class by separately tuning or adjusting different streams (e.g., two or more) that comprise an audio stream during an exercise class. Thus, regardless of the combination of music and instructor, a device presenting an exercise class enhances the audio stream of the class by separately enhancing the instructor stream and the music stream, providing the user with an improved user experience during the exercise class, among other benefits.

Various embodiments of the systems and methods will now be described. The following description provides specific details for a thorough understanding and an enabling description of these embodiments. One skilled in the art will understand, however, that these embodiments may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments.

### Examples of a Suitable Exercise Platform

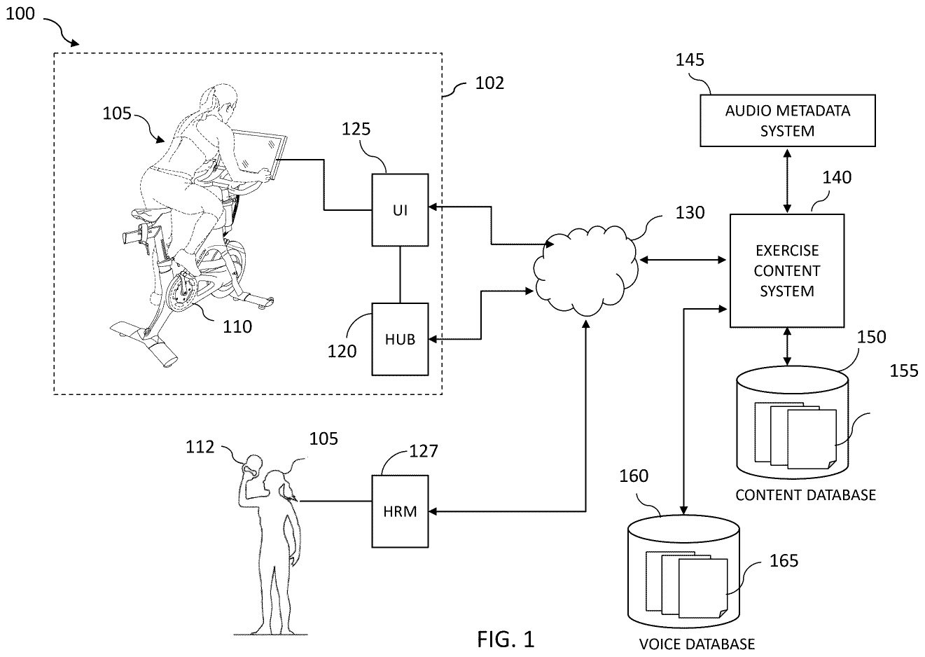

The technology described herein is directed, in some embodiments, to providing a user with an enhanced user experience when performing an exercise activity or workout. FIG. 1 is a block diagram illustrating a suitable network environment 100 for users of an exercise system.

The network environment 100 includes an activity environment 102, where a user 105 is performing an exercise activity, such as an indoor cycling activity. In some cases, the user 105 can perform the activity with an exercise machine 110, such as an exercise bicycle, a treadmill, a rowing machine, a stair climber, a strength machine, and so on.

In some cases, the exercise activity performed by the user 105 can include a variety of different workouts, activities, actions, and/or movements not associated with a machine, such as movements associated with lifting weights 112 (as shown), stretching, meditation, yoga, Pilates, rowing, running, cycling, jumping, sports movements (e.g., throwing a ball, pitching a ball, hitting, swinging a racket, swinging a golf club, kicking a ball, hitting a puck), and so on.

The activity environment 102 may include a home or home gym of the user, a commercial fitness center or gym, a hotel, a specific sports facility (e.g., yoga studio, batting cage, indoor track, and so on), an outdoor venue (e.g., a track, running path, street, park, and so on) or other workout facility or location that includes exercise machines, workout devices or accessories (e.g., weights, heavy bags, and so on). The exercise system, or platform, may access, obtain, and/or store information about the facility/location, such as the types of exercise machines or activities available to users, the hours available to utilize the facility/location, and so on.

The exercise machine 110 can assist or facilitate the user 105 to perform the movements and/or can present interactive content to the user 105 when the user 105 performs the activity. For example, the exercise machine 110 can be a stationary bicycle, a stationary rower, a treadmill, a weight machine, or other machines. As another example, the exercise machine 110 can be a display device that presents content (e.g., streamed classes, dynamically changing video, audio, video games, instructional content, workout instructions, and so on) to the user 105 during an activity or workout.

The exercise machine 110, in some embodiments, can include a media hub 120 and a user interface 125. The media hub 120, in some cases, captures images and/or video of the user 105, such as images of the user 105 performing different movements, or poses, during an activity. The media hub 120 can include a camera or cameras, a camera sensor or sensors, or other optical sensors configured to capture the images or video of the user 105.

In some cases, the media hub 120 includes components configured to present or display information to the user 105. For example, the media hub 120 can be part of a set-top box, mounted screen, or other similar device that outputs signals to a display, such as the user interface 125. Thus, the media hub 120 can operate to both capture images of the user 105 during an activity, while also presenting content (e.g., time- or distance-based experiences, streamed classes, workout statistics, and so on) to the user 105 during the activity.

The user interface 125 provides the user 105 with an interactive experience during the activity. For example, the user interface 125 can present user-selectable options that identify live classes available to the user 105, pre-recorded classes available to the user 105, historical activity information for the user 105, progress information for the user 105, instructional or tutorial information for the user 105, and other content (e.g., video, audio, images, text, and so on), that is associated with the user 105 and/or activities performed (or to be performed) by the user 105.

Further, in various embodiments, the media hub 120 can facilitate the tracking of movements or actions performed by the user 105, such as when the user is performing different movements as part of a strength or lifting class. The media hub 120, as described herein, can track and/or identify movements performed by the user 120.

In some cases, a heart rate monitor (HRM) 127 or other wearable device (e.g., smart watches, headphones, fitness trackers, augmented reality, virtual reality, extended reality (AR/VR/XR) displays or devices, GPS devices, smart glasses, and so on) can capture information about the user 105, such as heart rate and other biometric information, movement information (e.g., speed, distance, or acceleration information), sleep information, and so on. The HRM 127 can capture the user's heart rate and other information during machine-based activities and/or other activities, such as offline or class-based activities that do not utilize the exercise machine 110. In some cases, the exercise machine 110 can include components configured to capture biometric information for the user 105, such as heart rate information. Further, the HRM 127 or smart watch may also provide a user interface (e.g., the user interface 125) to the user.

The exercise machine 110, the media hub 120, and/or the user interface 125 can send or receive information over a network 130, such as a wireless network. Thus, in some cases, the user interface 125 is a display device (e.g., attached to the exercise machine 110), that receives content from (and sends information, such as user selections) an exercise content system 140 over the network 130. In other cases, the media hub 120 controls the communication of content to/from the exercise content system 140 over the network 130 and presents the content to the user via the user interface 125.

The exercise content system 140, located at one or more servers remote from the user 105, can include various content libraries (e.g., classes, movements, tutorials, and so on) and perform functions to stream or otherwise send content to the machine 110, the media hub 120, and/or the user interface 125 over the network 130. As described herein, the content may include an exercise class, such as an exercise class (e.g., presented in real-time or on demand) that plays music and includes instructions/cues/content spoken by an instructor leading the class.

A content database 150 stores content 155 (e.g., video files) that presents a pre-recorded class to a user. The content can include images, video, and other visual information that present the class, music, and other audio information to be played during the activity, and various overlay or augmentation information that is presented along with the audio/video content. Further, the database 150 can include various content libraries (e.g., classes, movements, tutorials, and so on) associated with the content presented to the user during a selected experience.

A voice database 160 stores voice or audio content 165, such as voice instructions generated by instructors or coaches within the connected fitness platform. In some cases, the voice or audio content 165 may be based on, or generated, by one or more large language models (LLMs), such as LLMs associated with each of the instructors. The voice or audio content 165 may also include certain characteristics or metadata associated with the instructors, such as data that identifies an instructor's vocal register, frequency range, or pitch.

The exercise content system 140 may be associated with an audio metadata system 145, which may operate or be configured to store and add metadata to the content 155 presented during exercise classes and other streamed content. For example, the audio metadata system 145 may receive content (e.g., an exercise class) and generate or select metadata to embed or otherwise add to the content. The metadata may include metadata associated with music with the content (e.g., metadata identifying a genre for the music (e.g., rock, hip hop, electronic), frequencies/pitches within a track, and so on). The metadata may also include metadata associated with an instructor for the class, such as metadata that identifies the instructor, characteristics of the voice of the instructor, and so on. Further details regarding the audio metadata system 145 are described herein.

FIG. 1 and the components, systems, servers, and devices depicted herein provide a general computing environment and network within which the technology described herein can be implemented. Further, the systems, methods, and techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to, floppy diskettes, optical discs, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other types of media/machine-readable medium suitable for storing electronic instructions.

The network 130, or cloud, can be any network, such as a wired or wireless local area network (LAN), a wired or wireless wide area network (WAN), the Internet, some other public or private network, a cellular (e.g., 4G, LTE, 5G, 6G network), and so on. While the connections between the various devices and the network 130 and are shown as separate connections, these connections can be any kind of local, wide area, wired, or wireless network, public or private.

Further, any or all components depicted in the Figures described herein can be supported and/or implemented via one or more computing systems, services (e.g., cloud instances), or servers. Although not required, aspects of the various components or systems are described in the general context of computer-executable instructions, such as routines executed by a general-purpose computer, e.g., mobile device, a server computer, or personal computer. The system can be practiced with other communications, data processing, or computer system configurations, including: Internet appliances, hand-held devices, wearable devices, or mobile devices (e.g., smart phones, tablets, laptops, smart watches), all manner of cellular or mobile phones, multi-processor systems, microprocessor-based or programmable consumer electronics, set-top boxes, network PCs, mini-computers, mainframe computers, AR/VR devices, gaming devices, and the like. Indeed, the terms “computer,” “host,” and “host computer,” and “mobile device” and “handset” are generally used interchangeably herein and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system may be distributed over the Internet or over other networks (including wireless networks), or they may be provided on any analog or digital network (packet switched, circuit switched, or other scheme). Portions of the system may reside on a server computer, while corresponding portions may reside on a client computer such as an exercise machine, display device, or mobile or portable device, and thus, while certain hardware platforms are described herein, aspects of the system are equally applicable to nodes on a network. In some cases, the mobile device or portable device may represent the server portion, while the server may represent the client portion.

### Examples of the Audio Equalization System

The connected fitness platform, as described herein, may facilitate and/or enhance the audio playback of an exercise class by separately tuning or adjusting different streams that comprise an audio stream during an exercise class.

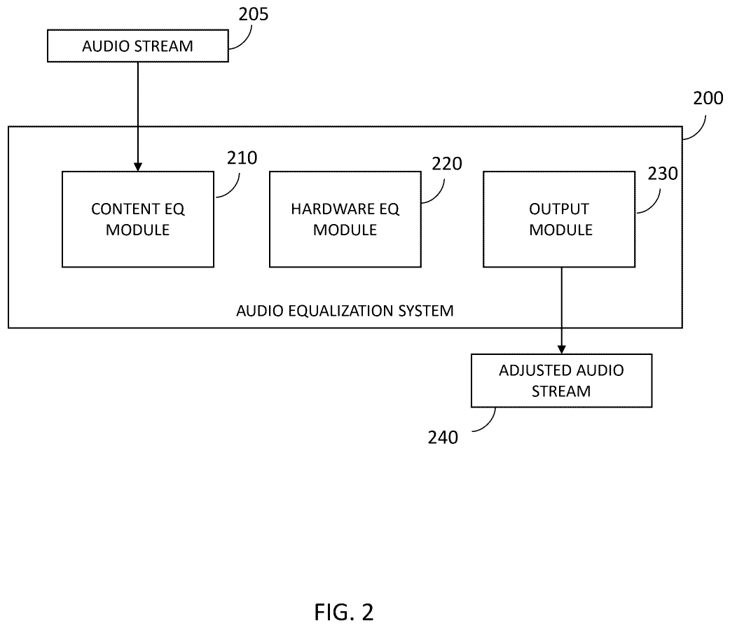

FIG. 2 is a block diagram illustrating components of an audio equalization system 200. The components and/or modules of the audio equalization system 200 can be implemented with a combination of software (e.g., executable instructions, or computer code) and hardware (e.g., at least a memory and processor). Accordingly, as used herein, in some embodiments, a component/module is a processor-implemented component/module and represents a computing device having a processor that is at least temporarily configured and/or programmed by executable instructions stored in memory to perform one or more of the functions that are described herein. The audio equalization system 200 includes a content EQ module 210, a hardware EQ module 220, and an output module 230.

As described herein, the audio equalization system 200 may be part of, or associated with, a display device, such as a display of the exercise machine 110. For example, the display device may include a display component that outputs video content of an exercise class presented to the user 105 of the exercise machine 110 and an audio component that outputs audio content of the exercise class presented to the user 105 of the exercise machine 110.

In some embodiments, the content EQ module 210 is configured and/or programmed to receive an audio stream 205, for the exercise class, including a music stream and an instructor stream, and separately equalize the music stream and the audio stream. For example, the content EQ module 210 may extract metadata from the two audio streams and adjust the music stream and the instructor stream (e.g., tuning certain frequencies) based on the extracted metadata. The metadata may include a first set of metadata that identifies a genre of music contained by the music stream and/or a second set of metadata identifies an instructor type associated with characteristics of a voice of an instructor providing spoken content contained by the instructor stream.

In some cases, the content EQ module 210 may access a data structure or table (e.g., a lookup table, or LUT) that maps music genre (or other tag) to a unique EQ curve for the music tracks within the music stream. For example, the metadata may identify a music track as “Country,” which points to or is associated with an EQ curve specific to that genre of music. In some cases, each track or set of music may have a specific or unique EQ curve.

For example, a music stream tagged as <r&b> may be associated with the following EQ curve:

Frequency Bands (Hz)

| | | | | | | | | | |
|---|---|---|---|---|---|---|---|---|---|
| 31.25 | 62.5 | 125.0 | 250.0 | 500.0 | 1000.0 | 2000.0 | 4000.0 | 8000.0 | 16000.0 |

R&B EQ Attenuation

| | | | | | | | | | |
|---|---|---|---|---|---|---|---|---|---|
| −4.3 | 0.0 | −1.2 | −5.6 | −9.1 | −8.4 | −4.6 | −4.2 | −3.9 | −3.1 |

where attenuation moves from no attenuation (0) to greater attenuation (larger negative values). Thus, low end frequencies (e.g., 100 Hz) are boosted to provide more bass, whereas the mid-range (around 800 Hz) is toned down, and high0end frequencies are reduced (2 KHz) while maintaining certain sounds (e.g., cymbals and brass) to be present. As a counter example, a music stream tagged as <pop> may enhanced the mid-range of the frequencies of the music. Similar EQ may be performed with instructor streams or other streams.

In some embodiments, the hardware EQ module 220 is configured and/or programmed to adjust an equalized music stream and an equalized audio stream based on hardware characteristics of the display device. For example, the hardware EQ module 220 may adjust the audio stream 205 (e.g., boost or attenuate certain frequencies) based on parameters or characteristics of the device that is playing back the audio stream, such as characteristics inherent to the device, the audio environment, and so on.

In some embodiments, the output module 230 is configured and/or programmed to provide the equalized music stream and the equalized audio stream to the audio component of the display device. For example, once the separate streams of the audio stream 205 have been adjusted/modified/enhanced, the output module 230 may provide an adjusted audio stream 240 to hardware audio components (e.g., sending an adjusted audio stream to a digital-to-analog converter (DAC) that drives speakers of the display device).

Thus, the audio equalization system 200 may be part of an audio flow where two streams (e.g., a music stream and an instructor stream) are received by an audio effects component of the device, such as an audio effect plugin (e.g., AFX for Android) that is part of an audio framework that outputs to a hardware abstraction layer (HAL), which drives the speakers of the device.

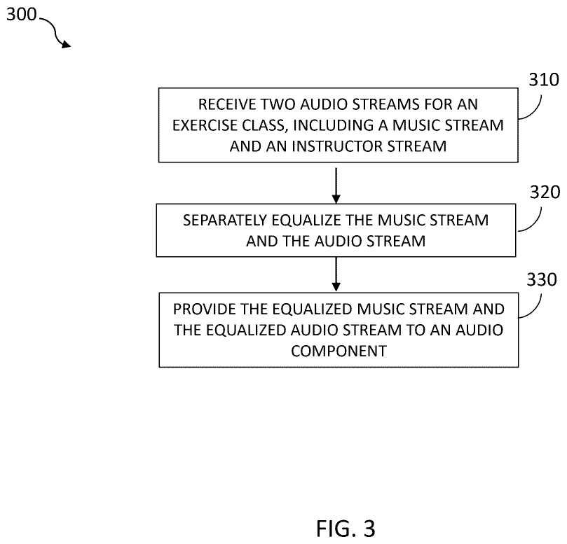

FIG. 3 is a flow diagram illustrating an example method 300 for equalizing an audio stream during an exercise class. The method 300 may be performed by the audio equalization system 200 and accordingly, is described herein merely by way of reference thereto. It will be appreciated that the method 300 may be performed on any suitable hardware.

In operation 310, the audio equalization system 200 receives two audio streams for the exercise class, including a music stream and an instructor stream. For example, the system 200 receives the audio stream 205, which includes two separate streams, one for the music played during the exercise class, and one for the instructor that provides verbal instructions, cues, and feedback during the exercise class.

In operation 320, the audio equalization system 200 separately equalizes the music stream and the audio stream. For example, the system 200 extracts metadata from the audio stream 205 and applies equalization (e.g., one or more EQ curves) based on the metadata (e.g., the metadata identifying a genre, type of instructor voice, identifier for a specific EQ curve, and so on).

As described herein, in some cases, the applied EQ curves may be based on the different streams within or combining to form the audio stream 205. For example, the system 200 process each stream via associated metadata, employing a LUT in the audio effects component (e.g., located in the hub 120 or display device) to adjust the processing of the streams. Thus, the adjustment to each stream may be based on metadata associated with that stream, metadata associated with that stream and another stream (e.g., both a music and instructor stream), and so on.

Also, while some examples present the use of two streams (e.g., a music and instructor stream), there may be cases where three or more streams combine to form the audio stream 205, where each stream has associated metadata. For example, an exercise class may have two instructors, and thus the audio stream 205 may include one music stream and two different instructor streams. As another example, an exercise class may present multiple types of music or content, and thus the audio stream 205 may include two music streams and one instructor stream. As another example, an exercise class may be a guided tour through a virtual environment, where the environment presents music/sounds through a variety of different streams, along with one or more instructor streams. Thus, the audio equalization system 200 may be employed to separately adjust, modify, and/or EQ many different streams for an exercise class or other exercise activity.

In operation 330, the audio equalization system 200 provides the equalized music stream and the equalized audio stream to the audio component. For example, the system 200 may output the equalized streams to a HAL layer of the device for output to a user during an exercise class.

In some embodiments, the exercise class may display information associated with the audio stream, such as information identifying the adjustments and/or modifications made to the audio stream for the exercise class. For example, the display component of the device may cause an indication of an equalized music stream and an equalized audio stream to be presented to a user via video content displayed during the exercise class.

Further, in some embodiments, the audio equalization system 200 may adjust or modify each of the audio streams based on user feedback or input. For example, the system 200 may receive user input associated with a request to modify the audio content of the exercise class (e.g., received via a user interface of the display device) and further equalize the music stream or the audio stream based on the user input.

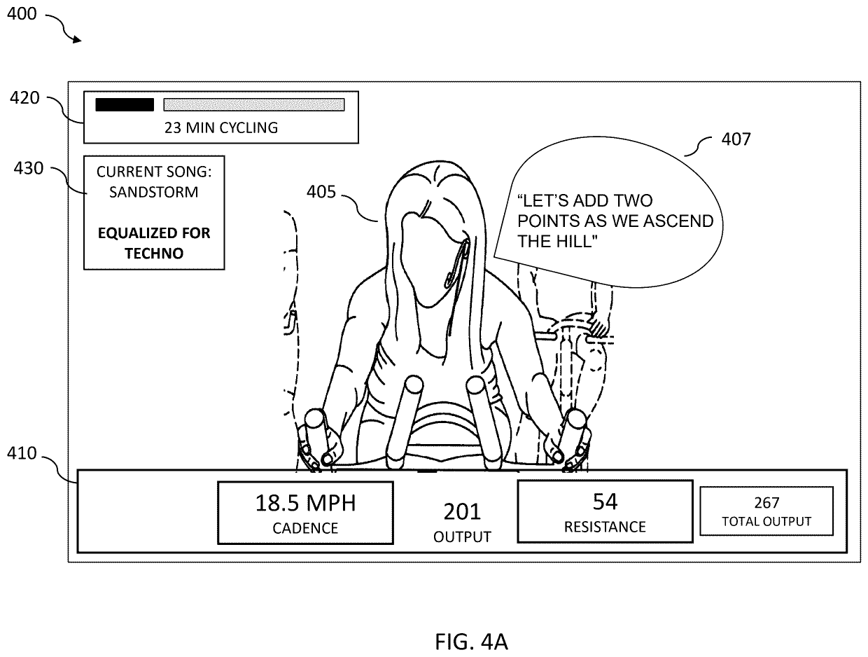

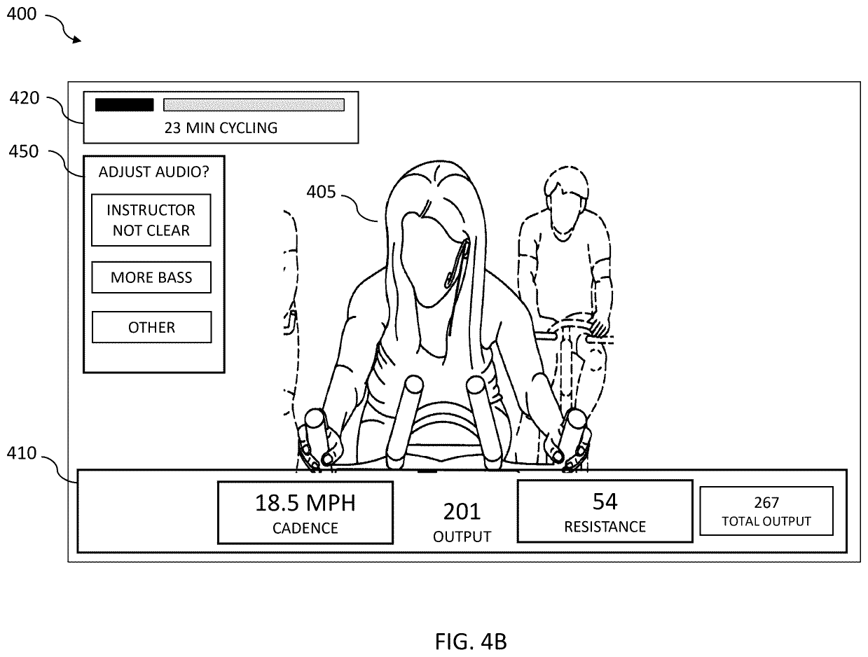

FIGS. 4A-4B are diagrams illustrating an exercise class 400 presented to a user of an exercise machine. As depicted in FIG. 4A, the exercise class 400 is streaming for a user performing an exercise activity on an exercise bicycle. The exercise class presents an instructor 405 that is speaking instructions 407 during the class, performance metrics 410, a class timeline 420, and music information 430 within a display of the exercise bicycle. As described herein, the music information 430 identifies a current song (e.g., an electronic music classic, “Sandstorm”) and information that the music was specifically modified for playback during the exercise class (e.g., “equalized for techno”). While there are no visual cues, the spoken instructions 407 have separately been equalized, as described herein, to increase their intelligibility during playback of the electronic music track.

FIG. 4B depicts a user feedback element 450, where a user may provide input to trigger or cause a further adjustment or enhancement to the audio playback during the exercise class 400. For example, the user may select one or more presented options to adjust the audio playback of the class and/or provide feedback, such as an option to request additional clarity for the instructor's cues (e.g., “instructor not clear”), an option to modify playback settings of the music (e.g., “more bass”), or other options. Thus, the system 200 enables the dynamic adjustment of audio playback of an exercise class by separately equalizing the music and instructor streams that combine to form the audio stream for the exercise class.

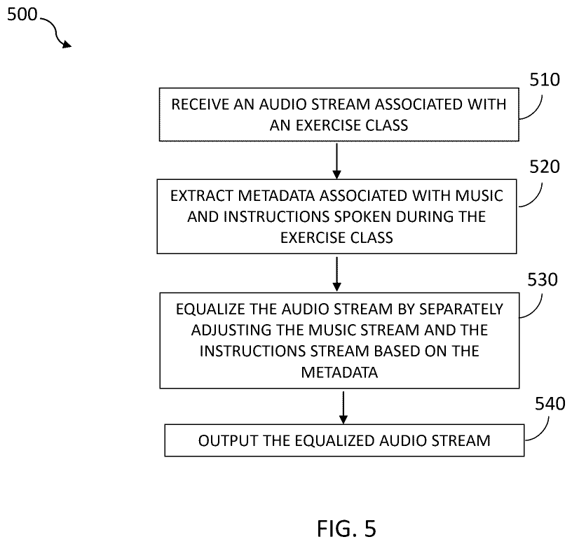

FIG. 5 is a flow diagram illustrating an example method 500 for playing an audio stream to a user of an exercise machine. The method 500 may be performed by the audio equalization system 200 and accordingly, is described herein merely by way of reference thereto. It will be appreciated that the method 500 may be performed on any suitable hardware.

In operation 510, the audio equalization system 200 receives an audio stream associated with an instructor-led exercise class. For example, the system 200, during an exercise class streaming in real-time, receives the audio stream 205 from a remote server associated with a connected fitness platform.

In operation 520, the audio equalization system 200 extracts metadata associated with music played during the exercise class and an instructor providing spoken instructions during the exercise class. For example, the system 200 may extract metadata that identifies a genre of music within the music stream and/or metadata that identifies a voice register for instructions spoken by an instructor within the instructor stream.

In operation 530, the audio equalization system 200 equalizes the audio stream by adjusting a music stream within the audio stream based on the extracted metadata and adjusting an instructor stream within the audio stream based on the extracted metadata. For example, the system 200 applies a first EQ curve to the music stream and a second EQ curve to the instructor stream, In operation 540, the audio equalization system 200 outputs the equalized audio stream during the instructor-led exercise class.

As described herein, the audio equalization system 200 may further modify the audio stream based on hardware or environment conditions/characteristics associated with the playback of the audio stream. Thus, the audio equalization system 200 may identify one or more hardware characteristics for an audio device that is outputting the equalized audio stream and equalize the audio streams based on the one or more hardware characteristics.

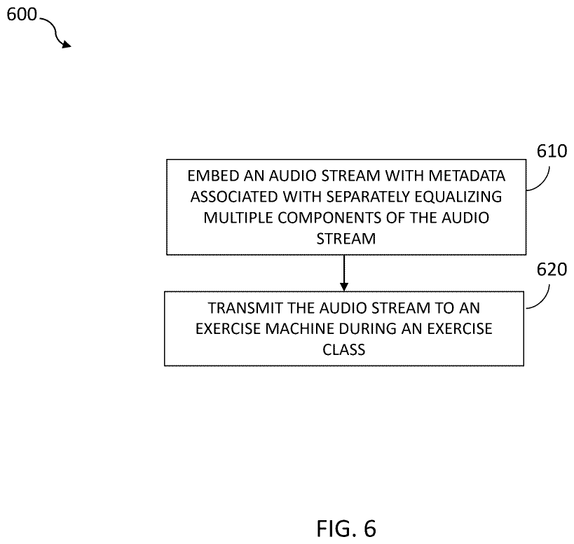

As described herein, the audio metadata system 145, which may be located at a remote server configured to stream exercise content to exercise machines, may operate or be configured to store and add metadata to the content 155 presented during exercise classes and other streamed content. FIG. 6 is a flow diagram illustrating an example method 600 for streaming audio content to a remote exercise machine. The method 600 may be performed by the audio metadata system 145 and accordingly, is described herein merely by way of reference thereto. It will be appreciated that the method 600 may be performed on any suitable hardware.

In operation 610, the audio metadata system 145 embeds an audio stream of an exercise class with metadata, where the metadata is associated with equalizing the audio stream at an exercise machine that presents the exercise class to a user. For example, the system 145 may embed different sets of metadata, including a first set of metadata associated with a music stream (e.g., a genre for music within the music stream) and a second set of metadata associated with an instructor stream (e.g., a voice register or pitch for spoken content within the instructor stream).

In operation 620, the audio metadata system 145 transmits the audio stream to the exercise machine during the exercise class. As described herein, the system 145 may transmit two or more separate streams, including a first audio stream that presents instructions spoken by an instructor leading the exercise class and a second audio stream that presents music played during the exercise class.

Thus, the various embodiments described herein enable the EQ, adjustment, and/or modification of audio streams during exercise classes by separately equalizing the different audio components (e.g., music and instructor spoken content) of the audio streams of the exercise classes. In doing so, a device (e.g., an exercise machine presenting the exercise class via a tablet) may provide an enhanced audio experience, where the music and instructor of the class are clearly heard without affecting the playback of one or the other, among other benefits.

### EXAMPLES EMBODIMENTS OF THE TECHNOLOGY

As described herein, the systems and methods may enable, support, and facilitate the enhancement of audio playback during streaming exercise classes, as set forth in the following example embodiments.

[to be finalized after inventor review—here to provide literal claim support]

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or”, in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the technology may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

From the foregoing, it will be appreciated that specific embodiments have been described herein for purposes of illustration, but that various modifications may be made without deviating from the spirit and scope of the embodiments. Accordingly, the embodiments are not limited except as by the appended claims.

What is claimed is:

1. A display device, comprising:
a display component that outputs video content of an exercise class presented to a user of an exercise machine associated with the display device;
an audio component that outputs audio content of the exercise class presented to the user of the exercise machine;
an audio equalization system associated with the audio component, wherein the audio equalization system is configured to:
receive two audio streams for the exercise class, including a music stream and an instructor stream;
separately equalize the music stream and the audio stream; and
provide the equalized music stream and the equalized audio stream to the audio component.

2. The display device of claim 1, wherein the audio equalization system is configured to separately equalize the music stream and the audio stream by:
extracting metadata from the two audio streams; and
adjusting the music stream and the audio stream based on the extracted metadata.

3. The display device of claim 2, wherein the metadata includes:
a first set of metadata that identifies a genre of music contained by the music stream; and
a second set of metadata identifies an instructor type associated with characteristics of a voice of an instructor providing spoken content contained by the instructor stream.

4. The display device of claim 1, wherein the audio equalization system is further configured to adjust the equalized music stream and the equalized audio stream based on hardware characteristics of the display device.

5. The display device of claim 1, wherein the display component is further configured to cause an indication of the equalized music stream and the equalized audio stream to be presented to the user via the video content of the exercise class.

6. The display device of claim 1, wherein the audio equalization system is further configured to:
receive, via a user interface of the display device, user input associated with a request to modify the audio content of the exercise class; and
further equalize the music stream or the audio stream based on the user input.

7. The display device of claim 1, wherein the exercise machine is a treadmill, an exercise bicycle, a rower, or a strength machine.

8. The display device of claim 1, wherein the display device is a tablet computer attached to the exercise machine and configured to stream, in real-time, the exercise class to the user of the exercise machine.

9. A method, comprising:
receiving an audio stream associated with an instructor-led exercise class;
extracting metadata associated with music played during the exercise class and an instructor providing spoken instructions during the exercise class;
equalizing the audio stream by:
adjusting a music stream within the audio stream based on the extracted metadata; and
adjusting an instructor stream within the audio stream based on the extracted metadata; and
outputting the equalized audio stream during the instructor-led exercise class.

10. The method of claim 9, further comprising:
identifying one or more hardware characteristics for an audio device that is outputting the equalized audio stream; and
equalizing the audio streams based on the one or more hardware characteristics.

11. The method of claim 10, wherein the audio device is a display associated with an exercise machine on which a user is performing an exercise activity and presenting the instructor-led exercise class.

12. The method of claim 10, wherein the extracted metadata includes metadata that identifies a genre of music within the music stream.

13. The method of claim 10, wherein the extracted metadata includes metadata that identifies a voice register for the instructions spoken by the instructor within the instructor stream.

14. The method of claim 10, further comprising:
receiving user input from a user of the exercise class; and
further adjusting the music stream or the instructor stream based on the user input.

15. A non-transitory computer-readable medium, whose contents, when executed by a computing system, cause the computing system to perform a method, the method comprising:
embed an audio stream of an exercise class with metadata,
wherein the metadata is associated with equalizing the audio stream at an exercise machine that presents the exercise class to a user;
transmit the audio stream to the exercise machine during the exercise class.

16. The non-transitory computer-readable medium of claim 15, wherein the audio stream includes a music stream and an instructor stream.

17. The non-transitory computer-readable medium of claim 16, wherein the metadata includes:
a first set of metadata associated with the music stream; and
a second set of metadata associated with the instructor stream.

18. The non-transitory computer-readable medium of claim 17, wherein the first set of metadata identifies a genre for music within the music stream.

19. The non-transitory computer-readable medium of claim 17, wherein the second set of metadata identifies a voice register for spoken content within the instructor stream.

20. The non-transitory computer-readable medium of claim 15, wherein the audio stream includes multiple separate streams, including:
a first stream that presents instructions spoken by an instructor leading the exercise class; and
a second stream that presents music played during the exercise class.
